(19) United States
(12) Patent Application Publication
(10) Pub. No.: US 2007/0288561 A1
(43) Pub. Date: Dec. 13, 2007

(54) Hyperlink-based notification system method

(76) Inventor: Fred K. Beckhusen, Allen, TX (US)

Correspondence Address: STEVEN W. SMITH, 7237 BIRCHWOOD DRIVE, DALLAS, TX, 75240, US

(21) Appl. No.: 11/439,360

(22) Filed: May 23, 2006

(51) Int. Cl. G06F 15/16

(52) U.S. Cl. 709/204

(57) ABSTRACT

An alarm system and method for communicating an alarm message from a client device to an identified recipient. No user-installed application programs related to the alarm system are stored on the client device. A hyperlink shortcut is automatically generated on the client device, linking the client device to an alarm server. A single action by the user activates the shortcut, sending an alarm message including a UserID, a PCName, and an alarm code to the server. The server accesses a database based on the information in the alarm message and retrieves recipient information including address, communication mode, and message content. The message content is then sent to at least one predefined recipient.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to communication systems. More particularly, and not by way of limitation, the invention is directed to a system and method for communicating an event-triggered message from a computing device to one or more identified personnel and/or organizations.

It is well known for conventional security systems to alert building occupants and law enforcement and emergency authorities upon the occurrence of a security violation at the secured premises. Many such systems are interconnected to a central monitoring station service system via a telecommunications line, such as a publicly switched telephone network (PSTN) or a wireless or RF communication network.

When an alarm is received at the central monitoring station, a person or staff at the monitoring station must view a list of stored telephone numbers and attempt to place calls to the subscribers or organizations at those numbers to tell them of the current security event. This is a time-consuming and inefficient process. Additionally, it is difficult for the subscriber to change the stored information, and the contact numbers frequently become obsolete and useless during an actual security breach.

A solution to this problem is proposed in U.S. Pat. No. 6,643,355 to Tsumpes. Tsumpes discloses an automated parallel and redundant subscriber contact and notification system capable of being triggered by the change in status of a sensing device or process including the sensor of an alarm system or other event. A client device is programmed to automatically contact of one or more persons over a plurality of telephonic and electronic communication channels, and provides the recipients with a detailed message including the date and time of a specific event which has occurred or failed to occur with respect to a monitored sensor. The device may be custom programmed by an authorized subscriber via a telephone interactive voice response system or Internet web page. The device may also be triggered or programmed to perform its notification based upon the input of a timer or another computer.

Many hospitals and organizations with large numbers of employees have a need for duress or panic type buttons. Hardwired buttons are expensive to install, and require testing and maintenance. Wireless panic buttons are also expensive. Several software solutions are now being offered to create software-based panic buttons. Systems exist that allow people under duress (clients) to press an Icon that loads a program that in turn signals first responders.

A shortcoming of Tsumpes and other automated notification systems, however, is that such systems invariably require the client to pre-load custom software programs on each client computer system to perform the alarm functions. In many environments, such as hospitals, the programming of network computers is carefully monitored and controlled. Only certain approved programs can be loaded onto the hospital's computers. The U.S. Food and Drug Administration (FDA) does not allow third-party software to be loaded onto computers that are also used for medical purposes because the software may compromise the behavior of these critical systems and cause life-threatening problems. The FDA requires medical equipment manufacturers to identify the specific methods they intend to use to prohibit such activity. Therefore, a system such as that disclosed by Tsumpes could not be utilized in the healthcare field because Tsumpes must load alarm-generating application programs onto individual computers (i.e., client devices).

Even if permission to load such a program is granted by the FDA and IT department, the programs themselves may require updates, scanning for viruses, and maintenance. A need exists for a new and novel method of signaling first responders without requiring such software to be permanently kept on client machines.

What is needed in the art is a system and method for communicating an event-triggered message from a computing device to one or more identified personnel and/or organizations that overcomes the shortcomings of the prior art. The present invention provides such a system and method.

### BRIEF SUMMARY OF THE INVENTION

In one aspect, the present invention is directed to a method of communicating an event-triggered message from a computing device to an identified recipient without having to maintain any alarm-generating application programs on the computing device. The method includes utilizing a shortcut-generating software program to create a hyperlink shortcut on the computing device that links the computing device with a server. The shortcut-generating program may then be deleted from the computing device. This is followed by sending the event-triggered message from the computing device to the server when the shortcut is activated by a user; determining by the server, a predefined mode of communicating with the identified recipient; and sending the event-triggered message from the server to the identified recipient utilizing the predefined mode of communicating.

In another aspect, the inventive method includes sending the alarm message from the client device to a server in response to only a single action being performed by a user. The alarm message includes an address for a server, an identity code for the user, and an alarm code. This is followed by extracting by the server, address information for the recipient based on the identity code for the user; and sending the alarm message from the server to the identified recipient utilizing the address information extracted from the database.

In another aspect, the present invention is directed to an alarm system for communicating an alarm message from a client device to an identified recipient. The system includes a client device, a server in communication with the client device, and a user database for storing and associating user identifiers, alarm codes, and alarm message content. The client device includes a hyperlink shortcut that activates a communication link without activating any alarm-generating application programs on the client device; and a single-action activation component that in response to performance of only a single action by a user, activates the hyperlink shortcut thereby sending an alarm message including an identifier for the client device and an alarm code. The server includes means for receiving the alarm message from the client device, a database controller for retrieving information from the user database based on the alarm message, and communication means for utilizing the information retrieved from the user database to send alarm message content to at least one predefined recipient.

In yet another aspect, the present invention is directed to a client device for communicating an alarm message to an alarm server. The client device includes a hyperlink shortcut to the alarm server; a single-action activation component that in response to performance of only a single action by a user, activates the hyperlink shortcut; and communication means for sending the alarm message when the hyperlink shortcut is activated, wherein the alarm message is sent without executing any alarm-generating application programs on the client device.

In yet another aspect, the present invention is directed to an alarm server for receiving an alarm message from a client device and sending alarm message content to a predefined recipient. The server includes means for receiving the alarm message from the client device, wherein the alarm message is sent in response to only a single action being performed by a user. The alarm message includes an identifier for the client device and an alarm code. The server also includes a database controller for retrieving address information and the alarm message content from a user database based on the identifier for the client device and the alarm code; and communication means for utilizing the address information retrieved from the user database to send the alarm message content to at least one predefined recipient.

In yet another aspect, the present invention is directed to a method of populating a plurality of computing devices with functionality to send an alarm message to a server. The method includes utilizing a shortcut-generating software program to create a hyperlink shortcut on a first computing device, wherein the shortcut is adapted to send the alarm message to the server in response to performance of only a single action by a user. The shortcut is then copied and distributed to the plurality of computing devices. The shortcut may be distributed over a local area network (LAN) or by electronic mail (e-mail).

### BRIEF DESCRIPTION OF THE SEVERAL VIEWS OF THE DRAWING

In the following, the essential features of the invention will be described in detail by showing preferred embodiments, with reference to the attached figures in which:

FIG. 1 is a flow chart of the automated process of creating a new shortcut in accordance with the teachings of the present invention;

FIG. 2 is a flow chart illustrating the steps of an overall alarm-reporting process in an exemplary embodiment of the present invention;

FIG. 3 is a flow chart illustrating the steps performed by the alarm server upon receiving an alarm message from the client computer in an exemplary embodiment of the present invention; and

FIG. 4 is a simplified block diagram of an exemplary embodiment of the system of the present invention.

### DETAILED DESCRIPTION OF THE INVENTION

The present invention provides a system and method for communicating an event-triggered message from a computing device to one or more identified personnel and/or organizations without permanently loading any user-installed application programs onto the computing device from which the alarm is triggered. The invention creates a shortcut or hyperlink on the computing device, which provides a link to a web server. When an end user either clicks on the hyperlink with a mouse or hits a Hotkey on a keyboard, the web server is notified, and the web server automatically sends stored notifications to identified personnel and/or organizations.

The present invention may also be used to generate a notice to a first responder in new and useful ways by using a variety of existing software applications, such as Word, Excel, or the default web browser that are already on the client machine, without loading any additional software on the client machine (other than the pre-approved package such as Excel or Word) with the appropriate coding as disclosed herein.

The resulting desktop shortcut may be encoded with specific information to be sent to first responders. For example, the shortcut may be encoded to send a message to a short message service (SMS) gateway, which sends a text message to a specified mobile phone when a duress event occurs. Alternatively, the shortcut may be encoded to send an e-mail or instant message. Optionally, the shortcut may be encoded to send a message to a specialized service provider that accesses a database to extract a predetermined alarm message and multiple destinations for further processing.

In Windows® operating systems, the standard method of creating a shortcut is a cumbersome process that is prone to errors. The user must first right-click the desktop and then click New Shortcut. The user must then type in the URL and name it. [sets off alarm] If the user desires to change the Icon and other properties associated with the new shortcut, the user must then right click the new shortcut and select the desired Icon and properties. Most users are familiar with only a few of the available Icons. To access other Icons, the user must change the direct link library (DLL) file to shell32.dll, which then reveals over one hundred Icon choices. Additional Icons may be accessed at moricons.dll.

The present invention includes a small downloadable program that performs the process of creating the new shortcut. The program is downloaded to the client computer as a temporary Internet file and is deleted from the client computer after use.

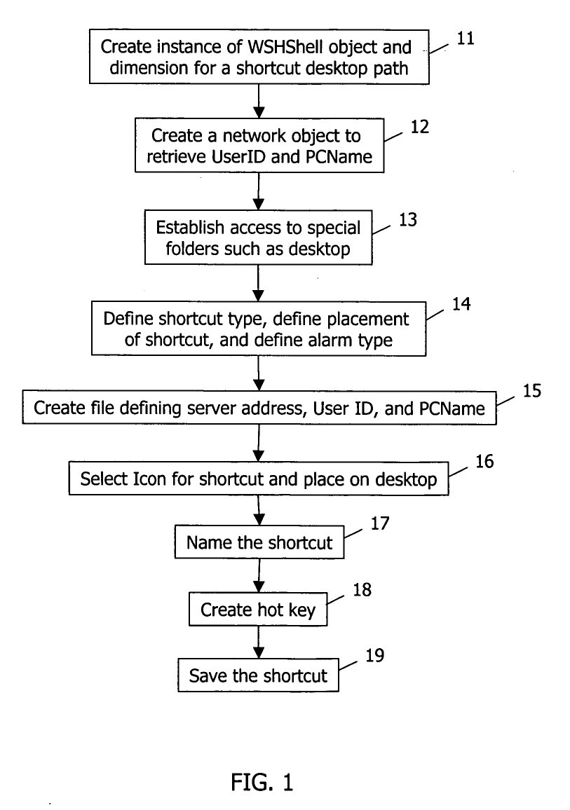

FIG. 1 is a flow chart of the automated process of creating a new shortcut in accordance with the teachings of the present invention. The program has parameters that are changed on-the-fly by the server scripts. The program is implemented in the context of an alarm-reporting system that reports an alarm condition to a predefined group of recipients when the user activates the shortcut on the client computer. Other uses of the program to send other types of messages are also within the scope of the present invention.

At step 11, the program creates an instance of the Windows Scripting Host Shell (WshShell) object and dimensions it for a shortcut desktop path. At step 12, the program creates a network object to retrieve the client computer's UserID and PCName properties. At step 13, the program establishes access to special folders such as the desktop. At step 14, the program defines the type of shortcut, defines the placement of the shortcut, and defines the alarm type associated with the shortcut. At step 15, a file is created to define the server address, the UserID, and the PCName. At step 16, the Icon for the shortcut is selected (for example from the shell32.dll file) and placed on the desktop. The shortcut is named at step 17, and a Hotkey (for example, “Ctrl+F1”) is created at step 18 as an alternative method of activating the shortcut. Finally, the shortcut is saved at step 19.

Thus, the program creates a hyperlink shortcut between the end-user's computer and a server. An Icon is selected from shell32.dll and a description of the shortcut is associated with the Icon. The program also sets up a Hotkey so that the end user can activate the shortcut without having to go back to the desktop screen and click on the Icon with a mouse. Note that the program also includes the end user's UserID, the client computer's PCName, and an alarm code in the message that is sent to the server. Therefore, the server is alerted to the nature of the event, the end user's identity, and the identity of the computer sending the message. The PCName is normally associated with a client computer at a particular location. Therefore, the recipient(s) of the message can tell where the message came from even if someone other than the normal end user activates the shortcut.

Once the program creates the shortcut, and the program is deleted, no alarm-generating, third-party, or user-installed application programs remain on the client computer. Additionally, the shortcut retains all its properties. This enables the user to copy the shortcut, distribute it to other computers or other users via a local area network (LAN) or by e-mailing the shortcut to them. In this way, the shortcut can be installed on “locked-down” (i.e., secure) computers without ever having to load software onto the locked-down computers.

When the present invention is utilized in an environment such as a bank or retail establishment, the shortcut may be utilized to alert law enforcement personnel of an emergency situation such as a robbery. With a single mouse click or keystroke, a teller or clerk can send the emergency signal to any number of predefined recipients. It is often desirable in this type of situation for the signal to be sent without alerting the would-be robber. If the robber realizes the teller or clerk has sent a panic signal, the robber may escape or may get angry and harm the teller or clerk. Therefore, the present invention may be set up to display a harmless looking screen after the shortcut is activated. For example, the program may display a spreadsheet or in the case of a retail establishment, a typical point-of-sale (POS) screen may be displayed.

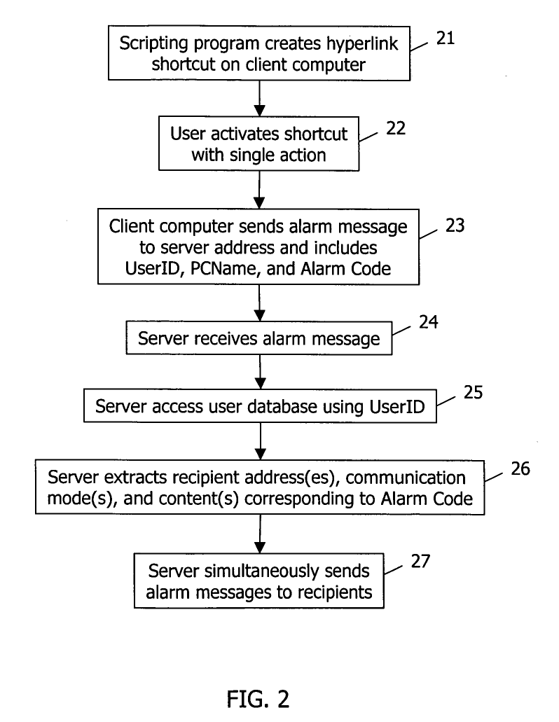

FIG. 2 is a flow chart illustrating the steps of an overall alarm-reporting process in an exemplary embodiment of the present invention. At step 21, the scripting program of FIG. 1 creates the hyperlink shortcut on the client computer. At step 22, the user activates the shortcut with a single action such as a mouse click on an Icon or pressing a Hotkey on a keyboard. At step 23, the client computer sends an alarm message to the server address and includes the UserID, PCName, and alarm code. At step 24, the server receives the alarm message. At step 25, the server accesses a user database using the UserID. At step 26, the server extracts one or more recipient addresses associated with the UserID, communication modes associated with each recipient, and message contents corresponding to the alarm code. At step 27, the server simultaneously sends alarm messages to the recipients with the extracted message contents and using the communication mode associated with each recipient.

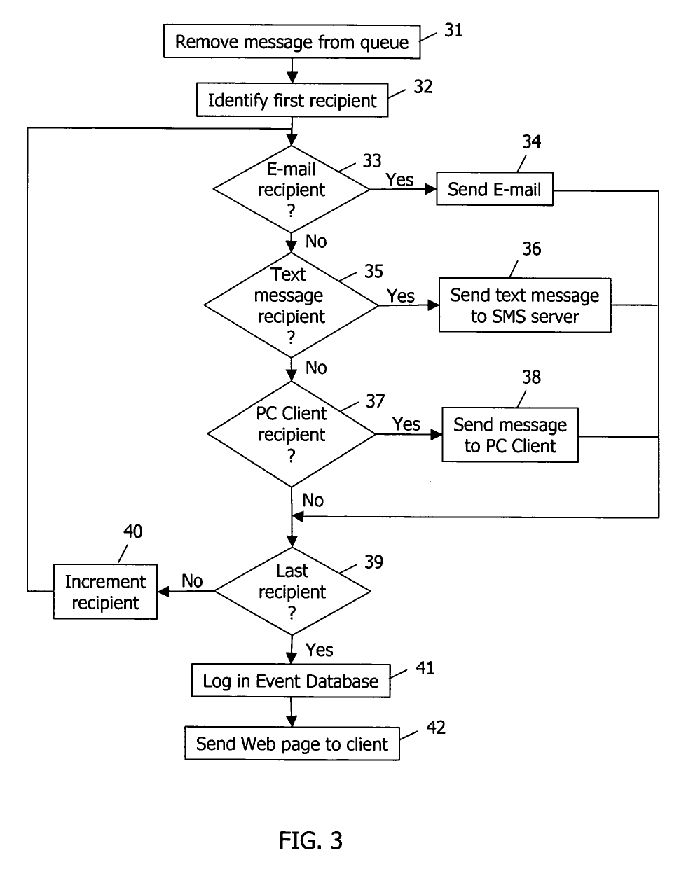

FIG. 3 is a flow chart illustrating the steps performed by the alarm server upon receiving an alarm message from the client computer in an exemplary embodiment of the present invention. At step 31, the server receives the alarm message from the client computer and removes it from the message queue. At step 32, the server accesses its database based on the UserID received in the alarm message and identifies the first recipient for the type of alarm identified by the alarm code. At step 33, it is determined whether the recipient is an e-mail recipient. If so, the process moves to step 34 where the server sends an e-mail message to the recipient with the text associated with the alarm type.

If the recipient is not an e-mail recipient, the process moves instead to step 35 where it is determined whether the recipient is a text message recipient. If so, the process moves to step 36 where the server sends a text message to the recipient with the text associated with the alarm type.

If the recipient is not a text message recipient, the process moves instead to step 37 where it is determined whether the recipient is PC client recipient. If so, the process moves to step 38 where the server sends a message to the PC client with the text associated with the alarm type.

At step 39, it is determined whether the recipient is the last recipient in the list of recipients associated with the UserID and alarm type. If not, the process increments the recipient at step 40 and returns to step 33. If the recipient is the last recipient, the process moves instead to step 41 where the alarm event is logged in an event database. At step 42, the server may send a web page to the client computer. Pushing the Hotkey or clicking on the Icon generates a request for a web page via the client's default web browser. The web server response to the browser request may be something as simple as a “200 OK” message, which produces a blank screen. Alternatively, the server may produce a message indicating that help is coming, or the server can cloak the response with a harmless looking screen such as a spreadsheet or POS screen.

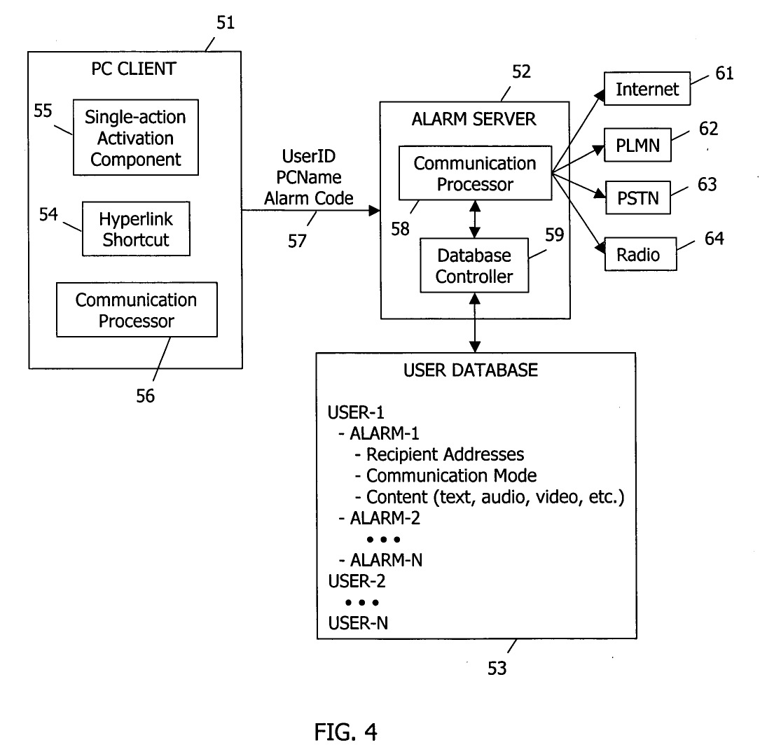

FIG. 4 is a simplified block diagram of an exemplary embodiment of the system of the present invention. The system includes a client device such as a PC client 51, an alarm server 52, and a user database 53. The client device includes a hyperlink shortcut 54 and no other alarm-generating application programs associated with the alarm system. A single-action activator 55 activates the shortcut in response to performance of only a single action by a user. For example, the user may ‘click’ on an Icon on the display screen or may press a Hotkey on the keyboard. Activation of the shortcut causes a communication processor 56 in the PC client to send an alarm message 57 to the server. No user-installed application programs on the client device are activated in this process. The alarm message may include an identifier for the user (UserID), an identifier for the PC client (PCName), and an alarm code.

The server 52 includes a communication processor 58 for receiving the alarm message from the PC client 51, and a database controller 59 for retrieving information from the user database 53 based on the alarm message. Entering the database using the UserID, the controller finds a number of alarm types (Alarm-1 through Alarm-N) associated with the UserID received from the PC client. Associated with each alarm type is a list of recipients. For each recipient, the database may store an address (e.g., IP address, e-mail address, phone number, and the like), a preferred communication mode (e.g., e-mail, text message, audio telephone message, and the like), and message content (e.g., text, audio, video, and the like). The message content may be the same for all recipients, or it may differ for each recipient.

Once the information is retrieved from the database, the server's communication processor 58 utilizes the information to send alarm message content to at least one predefined recipient. The communication mode utilized is the mode defined in the database for each recipient. For example, the message content may be sent through the Internet 61 as an e-mail message or PC client message; through the Public Land Mobile Network (PLMN) 62 as an audio or text message to a cell phone; through the Public Switched Telephone Network (PSTN) 63 as a landline call to a telephone; or via a radio frequency signal directly or indirectly to a radio receiver.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates any all modifications that fall within the scope of the invention defined by the following claims.

What is claimed is:

1. A method of communicating an event-triggered message from a computing device to an identified recipient, said method comprising:
utilizing a shortcut-generating software program to create a hyperlink shortcut on the computing device, said shortcut linking the computing device with a server;
deleting the shortcut-generating program from the computing device;
sending the event-triggered message from the computing device to the server when the shortcut is activated by a user;
determining by the server, a predefined mode of communicating with the identified recipient; and
sending the event-triggered message from the server to the identified recipient utilizing the predefined mode of communicating.

2. The method according to claim 1, wherein the event-triggered message includes an address for the server, an identity code for the recipient, and a message type code.

3. The method according to claim 2, wherein the event-triggered message also includes a user identity code for identifying the user of the computing device.

4. The method according to claim 3, wherein the event-triggered message also includes a device identity for identifying the computing device.

5. The method according to claim 3, wherein the step of utilizing a shortcut-generating software program to create a hyperlink shortcut includes inserting a user-defined text message in the event-driven message.

6. The method according to claim 2, wherein the step of determining a predefined mode of communicating with the identified recipient includes accessing a database by the server, and utilizing the recipient identity code to extract an indication of the predefined mode of communicating with the identified recipient and destination information for the recipient.

7. The method according to claim 6, wherein the step of sending the event-triggered message from the server to the identified recipient includes sending the event-triggered message via a communicating mode selected from a group consisting of:
an electronic mail (e-mail) message;
a short message service (SMS) text message;
an electronic pop-up message;
a pre-recorded audio cellular phone message;
a pre-recorded audio landline phone message;
a text-to-speech cellular phone message;
a text-to-speech landline phone message;
a facsimile message;
a pre-recorded radio point-to-point message; and
a pre-recorded radio broadcast message.

8. The method according to claim 2, wherein the event-triggered message includes an address for the server, a plurality of identity codes for a plurality of recipients, and a message type code, and the step of determining a predefined mode of communicating with the identified recipient includes accessing a database by the server, and utilizing the plurality of recipient identity codes to extract for each of the identified recipients, an indication of the predefined mode of communicating with the identified recipient and destination information for the recipient.

9. The method according to claim 1, wherein the step of utilizing a shortcut-generating software program to create a hyperlink shortcut includes creating an Icon on a visual display screen, wherein clicking the Icon with a mouse activates the hyperlink shortcut.

10. The method according to claim 9, wherein the step of utilizing a shortcut-generating software program to create a hyperlink shortcut also includes creating a Hotkey on a computer keyboard, wherein depressing the Hotkey activates the hyperlink shortcut.

11. A method of communicating an alarm message from a client device to an identified recipient, said method comprising:
sending the alarm message from the client device to a server in response to only a single action being performed by a user, said alarm message including an address for a server, an identity code for the user, and an alarm code;
extracting by the server, address information for the recipient based on the identity code for the user; and
sending the alarm message from the server to the identified recipient utilizing the address information extracted from the database.

12. The method according to claim 11, wherein the single action performed by the user is clicking on an Icon on a visual display screen to activate a hyperlink shortcut to the server.

13. The method according to claim 12, wherein the single action performed by the user is depressing a Hotkey on a keyboard to activate a hyperlink shortcut to the server.

14. An alarm system for communicating an alarm message from a client device to an identified recipient, said system comprising:
a client device comprising:
a hyperlink shortcut that activates a communication link without activating any alarm-generating application programs on the client device; and
a single-action activation component that in response to performance of only a single action by a user, activates the hyperlink shortcut;
a server in communication with the client device via the communication link, said server comprising:
means for receiving an alarm message sent from the client device in response to activation of the hyperlink shortcut, said alarm message including an identifier for the client device and an alarm code;
a database controller for retrieving information from a user database; and
communication means for utilizing the information retrieved from the user database to send alarm message content to at least one predefined recipient; and
a user database for storing and associating user identifiers, alarm codes, and alarm message content.

15. The alarm system according to claim 14, wherein the user database also stores a predefined mode of communicating with each predefined recipient.

16. A client device for communicating an alarm message to an alarm server, said client device comprising:
a hyperlink shortcut to the alarm server;
a single-action activation component that in response to performance of only a single action by a user, activates the hyperlink shortcut; and
communication means for sending the alarm message when the hyperlink shortcut is activated, wherein the alarm message is sent without executing any user-installed application programs on the client device.

17. The client device according to claim 16, wherein the alarm message includes a server address and an identifier that identifies the client device.

18. An alarm server for receiving an alarm message from a client device and sending alarm message content to a predefined recipient, said server comprising:
means for receiving the alarm message from the client device, said alarm message being sent in response to only a single action being performed by a user, said alarm message including an identifier for the client device and an alarm code;
a database controller for retrieving address information and the alarm message content from a user database based on the identifier for the client device and the alarm code; and
communication means for utilizing the address information retrieved from the user database to send the alarm message content to at least one predefined recipient.

19. A method of populating a plurality of computing devices with functionality to send an alarm message to a server, said method comprising:
utilizing a shortcut-generating software program to create a hyperlink shortcut on a first computing device, wherein the shortcut is adapted to send the alarm message to the server in response to performance of only a single action by a user;
copying the shortcut; and
distributing the copied shortcut to the plurality of computing devices.

20. The method according to claim 19, wherein the step of distributing the copied shortcut includes distributing the copied shortcut to the plurality of computing devices over a local area network.

21. The method according to claim 19, wherein the step of distributing the copied shortcut includes sending the copied shortcut to the plurality of computing devices via electronic mail.
